(19) United States
(12) Patent Application Publication
(10) Pub. No.: US 2012/0136672 A1
(43) Pub. Date: May 31, 2012

(54) Automated Surgery Notification System

(76) Inventor: Joshua B. Emert, Knoxville, TN (US)

(21) Appl. No.: 12/920,626

(22) PCT Filed: Aug. 20, 2009
(86) PCT No.: PCT/US09/54529

§ 371 Date: Sep. 2, 2010

(51) Int. Cl. G06Q 50/22

(52) U.S. Cl. 705/2

(57) ABSTRACT

A hospital operating room schedule notification system is described, where a data pipe extracts operating room schedules from the scheduling systems of subscribing hospitals, and makes the operating room schedules available to subscribing surgeons and attending device representatives according to a variety of selectable options.

This application claims all rights and priority on prior pending PCT application US2009/54529 filed 2009.08.20.

### FIELD

This invention relates to the field of resource scheduling. More particularly, this invention relates to the notification of scheduled operating room personnel, facilities, and resources to Internet and wireless device endpoints.

### BACKGROUND

Operating rooms are a valuable resource to the hospitals that provide them. The hospital is able to charge surgeons and patients for the specialized services and equipment that are provided with an operating room. These services and equipment are typically very expensive, and thus great care must be taken to ensure that the operating rooms are used in an efficient manner. For example, scheduling conflicts or other problems that would result in the operating room being under-utilized would tend to decrease the revenues generated by the operating room. Such inefficiencies could lead to a situation where the cost of maintaining the operating room exceeds the revenues generated by the operating room. Thus, using an operating room at a high level of efficiency is an important factor in hospital management.

When a surgery takes place involving instrumentation, implants, or any other such device, medical device representatives are usually involved to a high degree. Medical device representatives and the companies for whom they represent are responsible for ensuring the quality, safety, and availability of their devices when a surgeon chooses to use a company-specific product. Timely knowledge of the operating room schedule is essential to perform these duties, especially when one is away from the operating room. Any miscommunication, or even non-communication, regarding the details of a scheduled procedure not only greatly reduces the ability of the operating room to operate at its highest efficiency, it more importantly exposes the patient to a higher degree of risk.

What is needed, therefore, is a system whereby specific fields of the operating room schedule of a hospital are automatically extracted and delivered to personnel with an involvement in a given surgery, thereby reducing the risks associated with miscommunication and non-communication of information.

### SUMMARY

The above and other needs are met by a system for relaying otherwise static information to all involved personnel regarding scheduled operating rooms, the necessary resources thereof, and the procedures therein; the system having a system database for receiving schedule information in a system format, and a data pipe for retrieving the schedule information from a hospital operating room schedule database, where the schedule information is in a hospital format, converting the schedule information from the hospital format into the system format, and loading the schedule information into the system database.

A user interface is used for setting up accounts on the system for users, the accounts including, a device representative account, a surgeon account, and a hospital account, where the accounts permit only the users to receive schedule information from the system.

Account options are presented to the users, where the device representative account options include entering key words in regard to products and services offered by the device representative, searching for hospital accounts on the system, searching for surgeon accounts on the system, requesting access to the schedule information associated with hospital accounts, requesting access to the schedule information associated with surgeon accounts, viewing the schedule information for hospital accounts and surgeon accounts to which access has been granted, and setting options for receiving device representative alerts from the system.

The surgeon account options include viewing access requests from device representative accounts, and selectively approving and denying the requests, viewing device representative accounts that have been granted access to the surgeon account, viewing the key words for device representative accounts that have been granted access to the surgeon account, searching for hospital accounts on the system, requesting access to the schedule information associated with hospital accounts, viewing the schedule information for hospital accounts to which access has been granted, and setting options for receiving surgeon alerts from the system.

The hospital account options include, viewing access requests from device representative accounts and surgeon accounts, and selectively approving and denying the requests, viewing device representative accounts and surgeon accounts that have been granted access to the hospital account, viewing the schedule information for the hospital account, and setting options for sending surgeon alerts and device representative alerts from the system.

A processor is used for scheduling the retrieval of the schedule information, presenting account options, and receiving information from the users.

In various embodiments, the device representative account options further include at least one of: entering key words in regard to products and services offered by the device representative, and the surgeon account options further include viewing the key words for device representative accounts that have been granted access to the surgeon account; communication of alerts selectively via at least one of email, text to phone, voice to phone, and paging; sending a complete up-to-date schedule at a specified time on a specified daily frequency; sending schedule changes only at a specified time on a specified daily frequency; sending schedule changes only as soon as they are entered into the system; sending a complete up-to-date schedule at a specified time on a specified daily frequency, and sending schedule changes only as soon as they are entered into the system, and; setting a period of time covered by the schedule information in the alert.

In some embodiments the surgeon account option of selectively approving and denying access requests from device representative accounts includes granting a device representative account access to at least one of: all surgeries scheduled for the surgeon; a selectable subset of surgeries scheduled for the surgeon, and; surgeries scheduled for the surgeon that are associated with key words entered in regard to products and services offered by the device representative. In some embodiments the hospital account options further include overriding device representative account access that is granted by a surgeon account.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a flowchart for a login process according to an embodiment of the present invention.

FIG. 2 is a flowchart for a sales representative account according to an embodiment of the present invention.

FIG. 3 is a flowchart for a surgeon account according to an embodiment of the present invention.

FIG. 4 is a flowchart for a hospital account according to an embodiment of the present invention.

FIG. 5 is a flowchart for a data pipe according to an embodiment of the present invention.

FIG. 6 is a flowchart for a technical architecture according to an embodiment of the present invention.

### DETAILED DESCRIPTION

### Overview

The various embodiments of a system according to the present invention monitor changes in a hospital's master operating room schedule via the Internet, or some other global computer network. When an operating room case changes, additions or removals occur within the hospital's master schedule, and the relevant information in regard to those changes is forwarded to specific, subscribing users of the system. Thus, the system as exemplified herein is beneficial to keep interested parties, such as surgeons, hospital administrators, and device representatives, all up to date as to the scheduled usage of the hospital's operating rooms.

This information is of vital interest to all of the parties, for a variety of reasons. For example, the hospitals have an interest in maximizing the utilization of their operating rooms, which represent a profit-making asset of the hospital. Surgeons have an interest in knowing when changes occur to their schedules, or in publishing to hospitals and device representatives when they plan on performing certain procedures. Device representatives have an interest in knowing when schedules change, and when certain of their devices are needed for the various operating procedures that are scheduled. Thus, the embodiments of the present system keep all of the relevant parties up to date as to where and when certain procedures are to be performed, and the resources and personnel that are needed for those procedures.

Previously, there was nothing specific about how information regarding an operating room schedule was shared. There was a master print-out with the week's schedule for every operating room and every surgeon, which indicated what surgeon was using what company's products on what patient at what time and in which operating room. There was no way to selectively deliver just the relevant information to just those who needed it. Thus, the information delivered did not strictly conform to the HIPAA regulations because it divulged everyone's information to everyone, while at the same time overwhelming the information that was significant to a given person in a sea of information that was insignificant to that person.

Further, when surgeries were scheduled or changed after the master list was published, the device representative was not always informed of the change. Thus, the embodiments of the present invention reduce problems in three areas: HIPAA violations, non-communication of cases, and miscommunication of cases. Secondary benefits include greater hospital employee efficiencies and the ability for the relevant parties to check their schedules wirelessly or in other ways.

The system is a software application that is designed to work in conjunction with any existing operating room scheduling software. At the most basic level the system is an automated surgery notification system that seeks to keep surgeons, device representatives, and hospital staff members that have an interest in any surgery updated to any changes to any case. The updates are automatically exported from the hospital server and automatically delivered to subscribing members. The design is such that, beyond keeping an updated master schedule, no additional work is required from the hospital. In fact, the system tends to reduce hospital employee inefficiencies by eliminating the need to contact device representatives or others individually for each and every case. By reducing the potential risks of miscommunication and simultaneously refining HIPAA compliancy, patient care is improved.

The system aids the hospital's mission to serve in a number of ways. Currently, device representatives are informed of their cases about a week in advance of the scheduled surgeries, by meeting with their respective coordinator to go over the master schedule and sign off on their cases. The coordinator assumes that the device representative now has all the information needed, and the device representative assumes that he has his schedule for the following week. However, reality shows that neither of the two really has all the needed information, due to schedule changes. Thus, the coordinator is constantly contacting device representatives to tell them their changed schedule, and the device representative is constantly contacting the hospital to find out his new schedule.

The present system is a case-specific, “need-to-know” surgery notification system. The system provides the device representative with case-specificity, meaning that he will only receive case information relating to his products. “Need-to-know” provides the hospital better HIPAA compliancy positioning, informing only those device representatives explicitly involved in the surgery.

In order to protect patient privacy, data agents extract four fields from the existing schedule, including the surgeon, the time, the operating room, and the surgery details. That information is then sent only to those that need to know, who may then electronically sign off on the case, acknowledging to the specific coordinator that the device representative has seen and confirmed the case.

Another benefit to the hospital is the ability to view and print an attending device representative sheet each day. The attending device representative sheet is a list of the device representatives involved in the cases for the day, with the four fields of extracted data beside the name. Thus, the system condenses the master schedule into a streamlined, one-page list of who should be in attendance and why.

Another benefit to the hospital is mobility. Hospital administrators and staff, surgeons, and device representatives are able to view as far out into the schedule as cases have been scheduled from their home or from their phone. No longer will device representatives, surgeons, or operating room staff have to call in to find out the information they require.

As an overview, the system in one embodiment operates on a server processor that is remotely accessible by a number of different client processors, such as via the Internet or some other global computer network. The server in some embodiments is disposed at a single location, and in other embodiments is distributed via networking between many different sites. In addition, various portions of the system are redundantly deployed in some embodiments, so that if one deployment of a given function is rendered inoperable, a redundant deployment of that function can be brought online, either manually or automatically, so that the entire system remains operative at all times. The system or various portions thereof are implemented on processors such as personal computers in some embodiments, or on mainframe type processors in other embodiments.

### System Entry

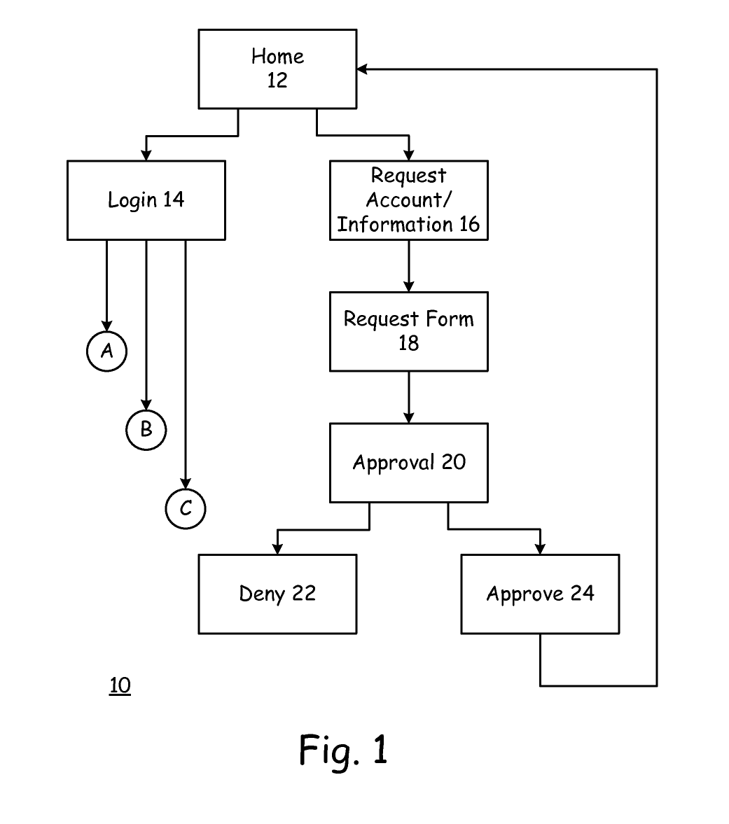

One embodiment of the method of entry to the system by a user is depicted in FIG. 1, where the user links to a home page 12. In some embodiments, this is accomplished by the user typing a specific address into a browser on a client computer, and accessing the home page 12 through the Internet. From the home page 12, the user is presented with various options, such as to log in to the system as given in block 14, or to request an account as given in block 16. If a new account is requested, a request form 18 is presented to the user. The request form determines, inter alia, the type of account that the user should be granted. For example, account types can include a hospital account, a surgeon account, and a device representative account. An approval process is initiated, as given in block 20, and the new account is either denied, as given in block 22, or approved as given in block 24. Once an account is approved, the user is able to log into their account, as given in block 14. The type of account that is established for the user determines the account options A, B, or C that are presented to them, as described in more detail below.

### Device Representative Account

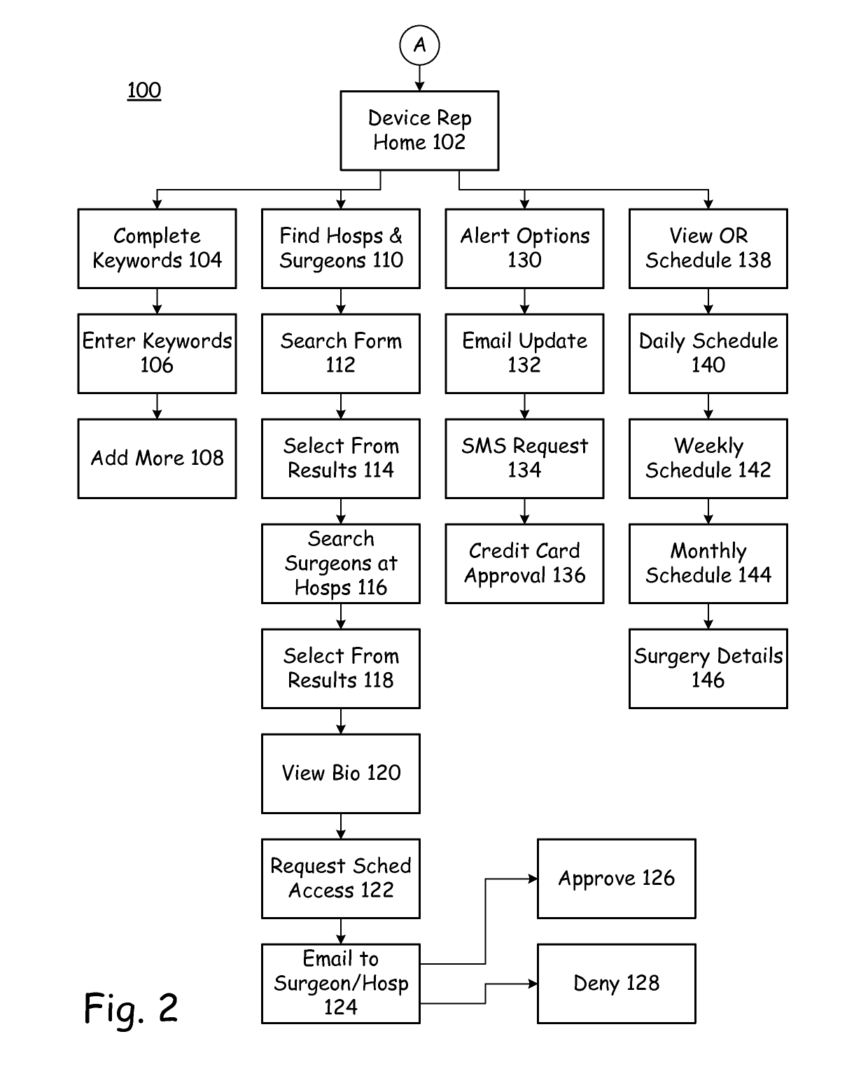

Entry to the device representative account is represented by the A link between block 14 of FIG. 1 and block 102 of FIG. 2. The device representative desires to receive information through the system in regard to the usage of his devices by surgeons within the device representative's sales area, or some other geographical or logical area. Thus, the device representative can select a menu option 104 to enter key words into the system. Key words are entered as given in block 106, and additional words are entered as given in block 108. The key words represent things such as the names or codes of set procedures, for which the device representative sells, provides, or maintains support materials, devices, or equipment, which a surgeon would either want or need during the procedure. Key words in some embodiments also include the generic or brand names of the resources that are provided by the device representative. Thus, the device representative desires to enter a sufficient number of relevant key words such that when a surgeon inputs his schedule of planned procedures, the system is able to make a match between the surgeon's schedule and the device representative's offerings.

The device representative is further able to enter a menu tree 110, whereby specific surgeons can be found, such as surgeons who are known to the device representative to perform procedures that are relevant to the device representative's offerings. The device representative enters data into a form 112 to search for hospitals at which relevant procedures are performed, and a list of the identified hospitals is presented, as given in block 114. The device representative can select the desired hospitals to search, and can then input criteria to search for specific surgeons who work out of those hospitals, as given in block 116. The list of identified surgeons is displayed, as given in block 118, and the device representative is able to view the biographies of the various surgeons, as desired, as given in block 120. The device representative is able to select those surgeons for whose schedules he would like to have access, as given in block 122, and the system generates an email request to the selected surgeons and their hospitals, as given in block 124. Those requests are either approved as given in block 126, or denied as given in block 128.

The device representative can select to be alerted to his key word hits according to a variety of different options, as present in block 130. For example, the device representative can select to be alerted via email as given in block 132, or via text messages as given in block 134. In some embodiments, the system generates revenue for the system providers by charging the device representatives for using the system, as given in block 136. Although the system is of general benefit to all of the users—be they device representatives, hospitals, or surgeons—it is the device representatives that derive revenue through the use of the system, whereby they are able to sell their materials for the scheduled procedures, and so deriving revenue from the device representatives to support the operation of the system strikes a good balance between the users.

The device representative can also view the operating room schedules, as given in block 138, for those hospitals that have granted him access to their schedules. The operating room schedules can be viewed on a daily basis as given in block 140, a weekly basis as given in block 142, or on a monthly basis as given in block 144. Details of the surgeries that are given in the schedule can be viewed as given in block 146.

The system narrows down the information that is presented to the device representatives, because it knows the surgeons that are subscribed to by the device representative, and the product names and nicknames provided in the key word section of his profile. For example, Rep Y requests access to Dr. X's schedule for cases involving his list of key words and product names related to his device offerings. Dr. X may either grant or deny access to any requesting device representative. If the device representative's query for access to a surgeon's schedule is denied, no data is forwarded to the device representative. If the access query is granted, any changes detected involving a device representative's subscribed surgeon and any one or combination thereof of his key words and product names are uploaded to the device representative's account calendar, and communicated to him via the pathway specified in the alert options section, such as email or text message. In some embodiments, case reminders can be selectively set to remind the device representative of a case at any given time before the case is set to begin.

### Surgeon Account

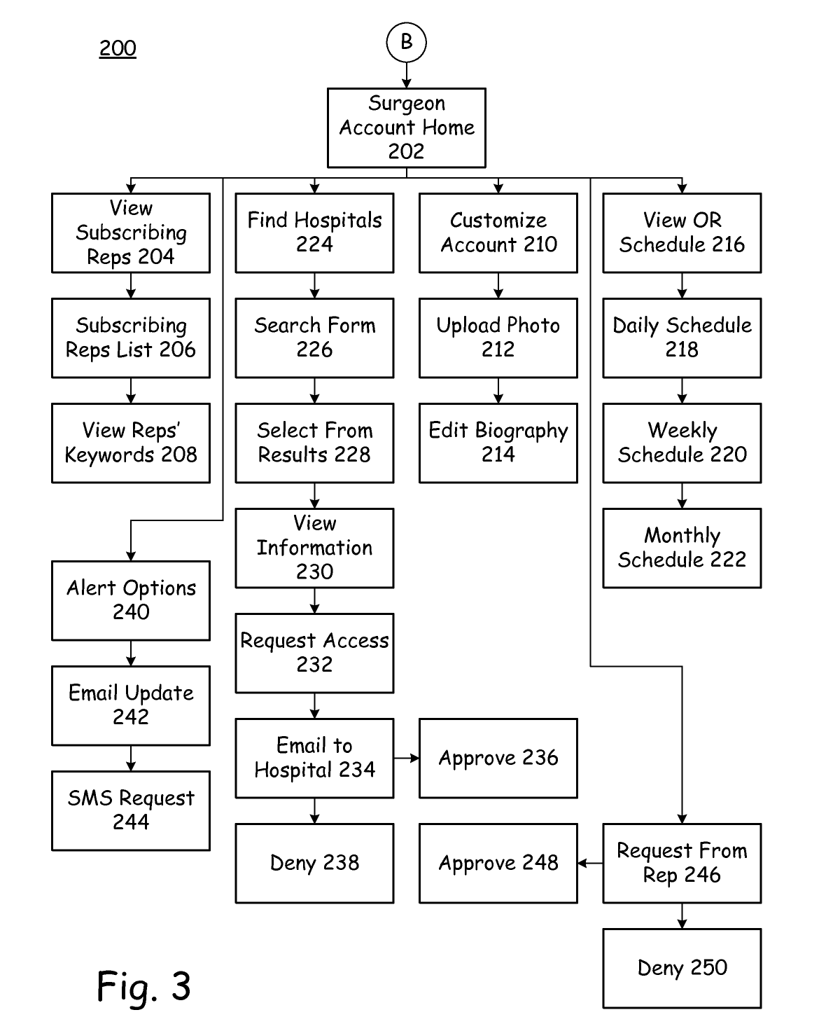

Entry to the surgeon account is represented by the B link between block 14 of FIG. 1 and block 202 of FIG. 3. The surgeon desires to use the system so as to have access to various device representatives that provide the materials required by the procedures performed by the surgeon, and to view changes to his operating room schedule. Upon logging into the system and arriving at his account home page 202, the surgeon is presented with various options that are selected specifically for his use. One option is to view the device representatives that are subscribed to him, as given in block 204, which can be displayed in a list as given in block 206. The surgeon is also able to review the key words that relate to the products and services provide by the device representatives, as given in block 208

The surgeon can also customize his account, as given in block 210. For example, the surgeon can upload his picture as given in block 212, and edit his biography as given in block 214, so that he is more easily found in the searches that are performed by the device representatives, as explained above, so that they can make their products and services available to him. The surgeon can also check the operating room calendar as given in block 216, such as in a daily view 218, a weekly view 220, or a monthly view 222.

The surgeon is further able to enter a menu tree 224, whereby specific hospitals can be found, such as hospitals that are known to provide operating rooms adapted for the procedures that are relevant to the surgeon's practice. The surgeon enters data into a form 226 to search for hospitals at which relevant procedures are performed, and list of the identified hospitals is presented, as given in block 228. The surgeon can select from the list of identified hospitals, and can then view the information in regard to those selected hospitals, as desired, as given in block 230. The surgeon is able to select those hospitals for which he would like to have access, as given in block 232, and the system generates an email request to the selected hospitals, as given in block 234. Those requests are either approved as given in block 236, or denied as given in block 238.

The surgeon can select to be alerted to changes in schedules, according to a variety of different options, as present in block 240. For example, the surgeon can select to be alerted via email as given in block 242, or via text messages as given in block 244. In some embodiments, the surgeon accounts receive all of the data that is related to the cases that are attributed to the surgeon's name on the hospital's master schedule. The data is uploaded to the surgeon's account calendar, and communicated to him, such as by email or text messaging. Surgeons also have the ability to set case reminders at any specified time before a case begins.

Surgeon's also have the option to review the access requests from the various device representatives, as given in block 246, which requests the surgeon can either approve as given in block 238, or deny as given in block 250.

### Hospital Account

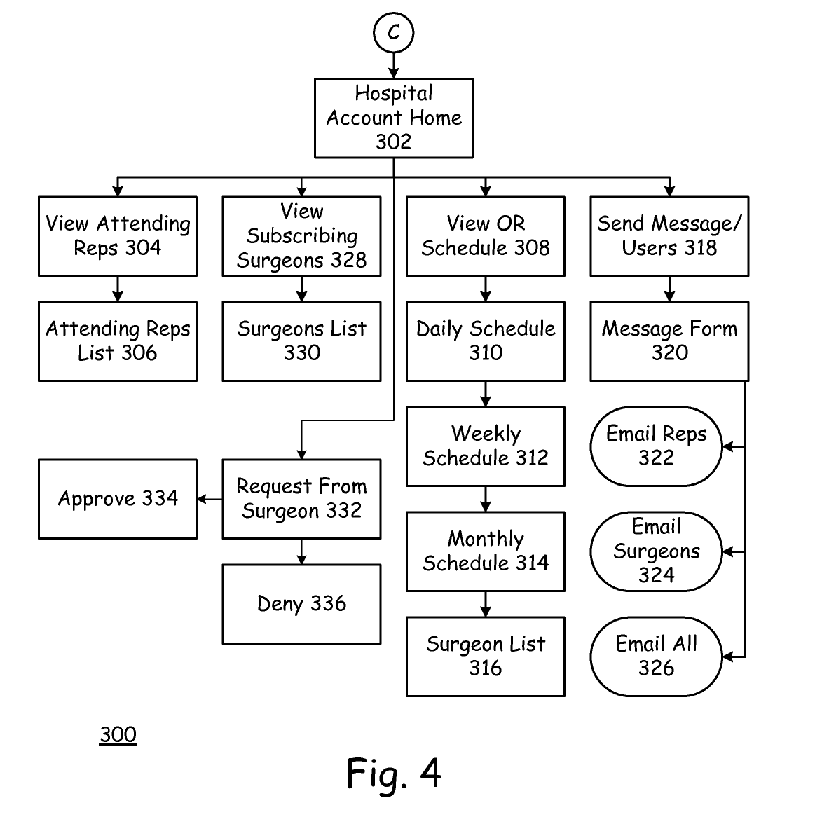

Entry to the hospital account is represented by the C link between block 14 of FIG. 1 and block 302 of FIG. 4. The hospital desires to provide schedule information to various device representatives and surgeons that use the operating rooms, so that the use of the operating rooms can be increased and delays and other interruptions can be reduced. Upon logging into the system and arriving at the account home page 302, the hospital is presented with various options that are selected specifically for their use. The hospital account provides access to the schedule for the hospital's operating rooms, as given in block 308, by the day as given in block 310, by the week as given in block 312, or by the month as given in block 314.

Hospitals also have the ability to view attending device representatives as given in block 304, and generate a list of representatives as given in block 306. Such information also includes, in some embodiments, the list as associated with the data sorted by individual cases and why the attendance of the device representative is required. Similar information can be viewed for the surgeons as given in block 328, and a list generated as given in block 330. As previously described, surgeons can request access to the hospital schedule, which the hospital can view in block 332, and approve as given in block 334, or deny as given in block 336.

The Hospital account has a message system as given in block 318, through which the hospital can contact one or more of the subscribing surgeons and device representatives. For example, the message form can be filled out as given in block 320, with delivery specified for selected device representatives as given in block 322, selected surgeons as given in 324, or both as given in block 326.

### Data Pipe

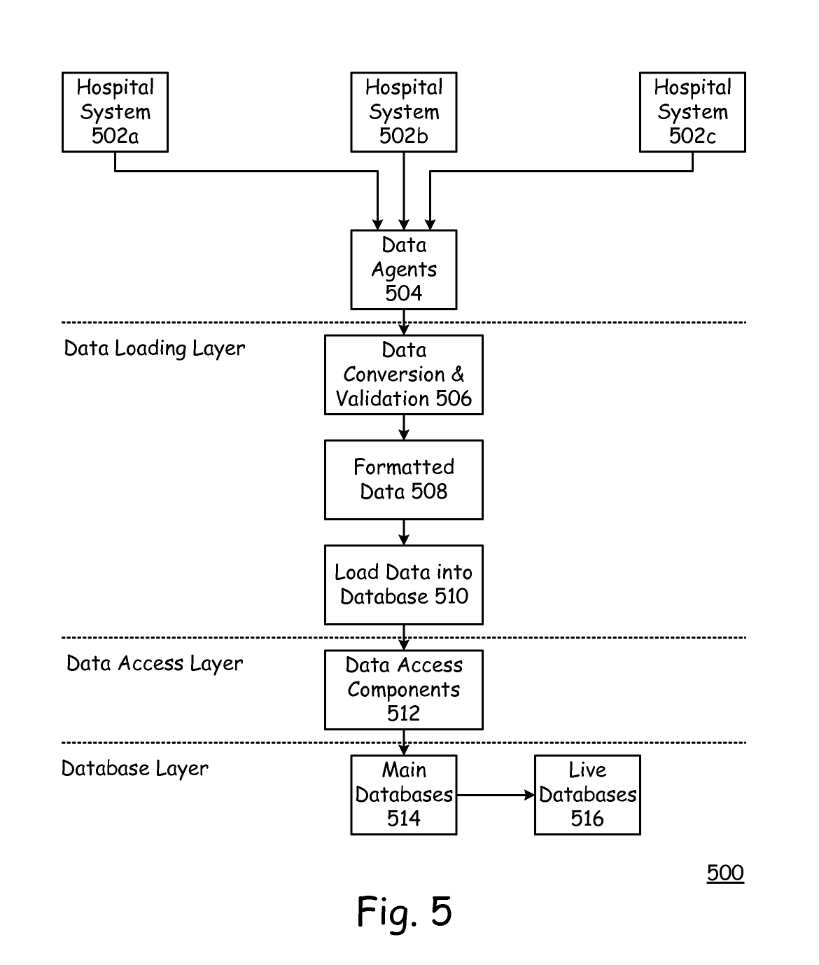

The system data pipe 500, as describe in reference to FIG. 5, is that portion of the system that gathers information from the hospital data systems 502a, 502b, and 502c, for example, and automatically uploads it to the system databases 514 and 516, as next described. The data agents 504 are granted access credentials to the hospital data systems 502, such as when the hospital accounts are created, and down load the schedule data from the hospital data system 502 according to a given schedule. For example, the schedule could be daily or hourly, or could be event driven, such as whenever a schedule change is made to the hospital system 502.

The data agents 504 feed the data from the hospital systems 502 to a data conversion and validation routine 506, which converts the data format from the native format of the hospital system 502 to the format as desired for the system data bases 514 and 516. A validation of the data, such as after the conversion process, ensures that the data as received from the hospital systems 502 is not corrupted, for example. The data is further formatted as given in block 508 for the use of the system, and loaded into the system databases 514 and 516 as given in block 510, passing through the data access components of the data pipe, as given in block 512.

### System Architecture

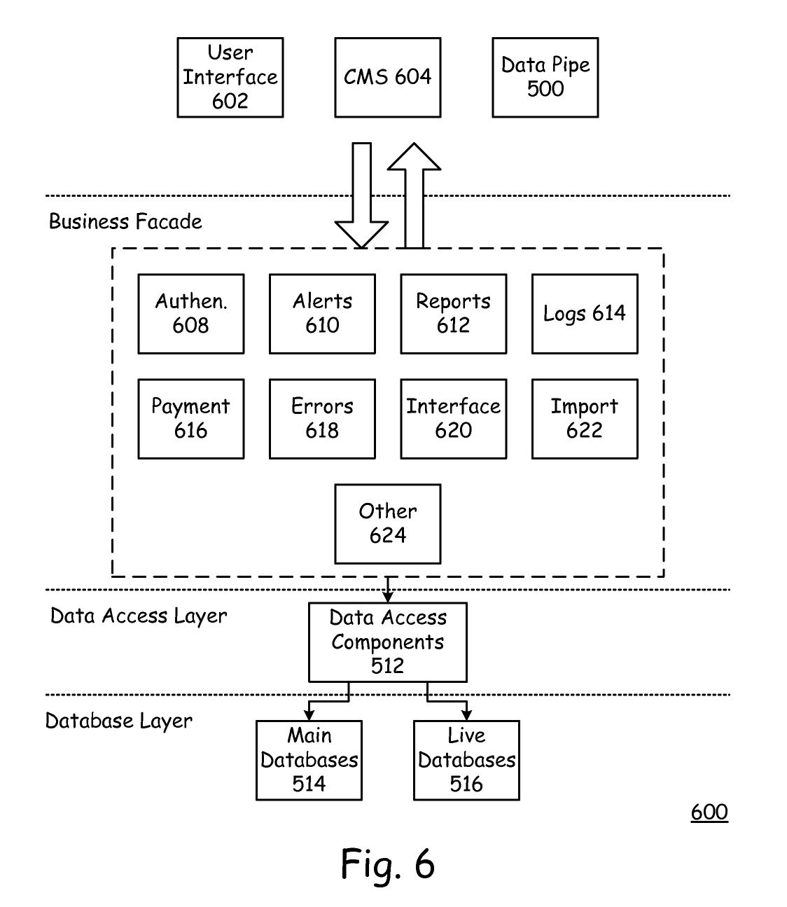

One model of the system architecture 600 is provided in FIG. 6, and includes the user interfaces 602, the CMS 604, and the data pipe 500, all as described above. Within the business façade are various components 608-624 for handling a variety of tasks as generally described and alluded to in the descriptions provided above. The components 608-624 of the façade are in communications with the data bases 514 and 516 through the data access components 512.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A system for communicating operating room schedule information, the system comprising:
a system database for receiving schedule information in a system format,
a data pipe for,
retrieving the schedule information from a hospital operating room schedule database, where the schedule information is in a hospital format,
converting the schedule information from the hospital format into the system format, and
loading the schedule information into the system database,
a user interface for,
setting up accounts on the system for users, the accounts including,
a device representative account,
a surgeon account, and
a hospital account,
where the accounts permit only the users to receive schedule information from the system, and
presenting account options to the users, where,
the device representative account options include,
searching for hospital accounts on the system,
searching for surgeon accounts on the system,
requesting access to the schedule information associated with hospital accounts,
requesting access to the schedule information associated with surgeon accounts,
viewing the schedule information for hospital accounts and surgeon accounts to which access has been granted, and
setting options for receiving device representative alerts from the system,
the surgeon account options include,
viewing access requests from device representative accounts,
viewing device representative accounts that have been granted access to the surgeon account,
searching for hospital accounts on the system,
requesting access to the schedule information associated with hospital accounts,
viewing the schedule information for hospital accounts to which access has been granted, and
setting options for receiving surgeon alerts from the system, and
the hospital account options include,
viewing access requests from device representative accounts and surgeon accounts, and selectively approving and denying the requests,
viewing device representative accounts and surgeon accounts that have been granted access to the hospital account,
viewing the schedule information for the hospital account, and
setting options for sending surgeon alerts and device representative alerts from the system, and
a processor for scheduling the retrieval of the schedule information, presenting account options, and receiving information from the users.

2. The system of claim 1, wherein:
the device representative account options further include validating key words in regard to products and services offered by the device representative, and
the surgeon account options further include viewing the key words for device representative accounts that have been granted access to the surgeon account.

3. The system of claim 1, wherein setting options for sending and receiving surgeon alerts and device representative alerts includes communication of alerts selectively via at least one of email, text to phone, voice to phone, and paging.

4. The system of claim 1, wherein setting options for sending and receiving surgeon alerts and device representative alerts includes sending a complete up-to-date schedule at a specified time on a specified daily frequency.

5. The system of claim 1, wherein setting options for sending and receiving surgeon alerts and device representative alerts includes sending schedule changes only at a specified time on a specified daily frequency.

6. The system of claim 1, wherein setting options for sending and receiving surgeon alerts and device representative alerts includes sending schedule changes only as soon as they are entered into the system.

7. The system of claim 1, wherein setting options for sending and receiving surgeon alerts and device representative alerts includes:
sending a complete up-to-date schedule at a specified time on a specified daily frequency, and
sending schedule changes only as soon as they are entered into the system.

8. The system of claim 1, wherein setting options for sending and receiving surgeon alerts and device representative alerts includes setting a period of time covered by the schedule information in the alert.

9. The system of claim 1, wherein the hospital account option of selectively approving and denying access requests from device representative accounts includes granting a device representative account access to at least one of: all surgeries scheduled for the surgeon; a selectable subset of surgeries scheduled for the surgeon; surgeries scheduled for the surgeon that are associated with key words entered in regard to products and services offered by the device representative.

10. The system of claim 1, wherein the hospital account options further include overriding device representative account access that is granted by a surgeon account.

11. Instructions disposed on a computer readable medium, the instructions operable for configuring a computer system to communicate operating room schedule information, the instructions comprising modules for implementing in the computer system:
a system database for receiving schedule information in a system format,
a data pipe for,
retrieving the schedule information from a hospital operating room schedule database, where the schedule information is in a hospital format,
converting the schedule information from the hospital format into the system format, and
loading the schedule information into the system database,
a user interface for,
setting up accounts on the system for users, the accounts including,
a device representative account,
a surgeon account, and
a hospital account,
where the accounts permit only the users to receive schedule information from the system, and
presenting account options to the users, where,
the device representative account options include,
validating key words in regard to products and services offered by the device representative,
searching for hospital accounts on the system,
searching for surgeon accounts on the system,
requesting access to the schedule information associated with hospital accounts,
requesting access to the schedule information associated with surgeon accounts,
viewing the schedule information for hospital accounts and surgeon accounts to which access has been granted, and
setting options for receiving device representative alerts from the system,
the surgeon account options include,
viewing access requests from device representative accounts,
viewing device representative accounts that have been granted access to the surgeon account,
viewing the key words for device representative accounts that have been granted access to the surgeon account,
searching for hospital accounts on the system,
requesting access to the schedule information associated with hospital accounts,
viewing the schedule information for hospital accounts to which access has been granted, and
setting options for receiving surgeon alerts from the system, and
the hospital account options include,
viewing access requests from device representative accounts and surgeon accounts, and selectively approving and denying the requests,
viewing device representative accounts and surgeon accounts that have been granted access to the hospital account,
viewing the schedule information for the hospital account, and
setting options for sending surgeon alerts and device representative alerts from the system.

12. The instructions of claim 11, wherein setting options for sending and receiving surgeon alerts and device representative alerts includes communication of alerts selectively via at least one of email, text to phone, voice to phone, and paging.

13. The instructions of claim 11, wherein setting options for sending and receiving surgeon alerts and device representative alerts includes sending a complete up-to-date schedule at a specified time on a specified daily frequency.

14. The instructions of claim 11, wherein setting options for sending and receiving surgeon alerts and device representative alerts includes sending schedule changes only at a specified time on a specified daily frequency.

15. The instructions of claim 11, wherein setting options for sending and receiving surgeon alerts and device representative alerts includes sending schedule changes only as soon as they are entered into the system.

16. The instructions of claim 11, wherein setting options for sending and receiving surgeon alerts and device representative alerts includes:
sending a complete up-to-date schedule at a specified time on a specified daily frequency, and
sending schedule changes only as soon as they are entered into the system.

17. The instructions of claim 11, wherein setting options for sending and receiving surgeon alerts and device representative alerts includes setting a period of time covered by the schedule information in the alert.

18. The instructions of claim 11, wherein the hospital account option of selectively approving and denying access requests from device representative accounts includes granting a device representative account access to at least one of: all surgeries scheduled for the surgeon; a selectable subset of surgeries scheduled for the surgeon; surgeries scheduled for the surgeon that are associated with key words entered in regard to products and services offered by the device representative.

19. The instructions of claim 11, wherein the hospital account options further include overriding device representative account access that is granted by a surgeon account.

20. A processor-based method for communicating operating room schedule information, the method comprising the steps of:
retrieving schedule information from a hospital operating room schedule database, where the schedule information is in a hospital format,
converting the schedule information with the processor from the hospital format into a system format, and
loading the schedule information into a system database with the processor,
setting up accounts on the system for users, the accounts including,
a device representative account,
a surgeon account, and
a hospital account,
where the accounts permit only the users to receive schedule information from the system,
selectively presenting device representative account options, including,
validating key words in regard to products and services offered by the device representative,
searching for hospital accounts on the system,
searching for surgeon accounts on the system,
requesting access to the schedule information associated with hospital accounts,
requesting access to the schedule information associated with surgeon accounts,
viewing the schedule information for hospital accounts and surgeon accounts to which access has been granted, and
setting options for receiving device representative alerts from the system,
selectively presenting surgeon account options, including,
viewing access requests from device representative accounts,
viewing device representative accounts that have been granted access to the surgeon account,
viewing the key words for device representative accounts that have been granted access to the surgeon account,
searching for hospital accounts on the system,
requesting access to the schedule information associated with hospital accounts,
viewing the schedule information for hospital accounts to which access has been granted, and
setting options for receiving surgeon alerts from the system, and
selectively presenting hospital account options, including,
viewing access requests from device representative accounts and surgeon accounts, and selectively approving and denying the requests,
viewing device representative accounts and surgeon accounts that have been granted access to the hospital account,
viewing the schedule information for the hospital account, and
setting options for sending surgeon alerts and device representative alerts from the system.
